(19) United States
(12) Patent Application Publication
(10) Pub. No.: US 2014/0088219 A1
(43) Pub. Date: Mar. 27, 2014

(54) MOISTURE CURABLE COMPOSITIONS AND LOW SURFACE ENERGY COATING COMPOSITIONS MADE THEREFROM

(71) Applicants: Hongyu Chen, Shanghai (CN); Yan Huang, Shanghai (CN); Yanxiang Li, Midland, MI (US); John A. Roper, III, Midland, MI (US); Christopher J. Tucker, Midland, MI (US); Gerald A. Vandezande, Raleigh, NC (US); Yu Zhang, Shanghai (CN); Guozhu Li, Tianjin (CN); John Klier, Midland, MI (US)

(72) Inventors: Hongyu Chen, Shanghai (CN); Yan Huang, Shanghai (CN); Yanxiang Li, Midland, MI (US); John A. Roper, III, Midland, MI (US); Christopher J. Tucker, Midland, MI (US); Gerald A. Vandezande, Raleigh, NC (US); Yu Zhang, Shanghai (CN); Guozhu Li, Tianjin (CN); John Klier, Midland, MI (US)

(73) Assignees: ROHM AND HAAS COMPANY, Philadelphia, PA (US); DOW GLOBAL TECHNOLOGIES LLC, Midland, MI (US)

(21) Appl. No.: 14/113,409

(22) PCT Filed: Nov. 10, 2011
(86) PCT No.: PCT/CN2011/082042

§ 371 Date: Dec. 2, 2013

(30) Foreign Application Priority Data
Apr. 25, 2011 (CN) 201110115973.6

(51) Int. Cl. C09D 175/04; C09D 5/14; C09D 5/16

(52) U.S. Cl. CPC C09D 175/04; C09D 5/1675; C09D 5/14
USPC 523/122; 524/588

(57) ABSTRACT

A one-package moisture curable composition is provided. The composition comprises, by weight percentage based on the dry weight of the composition, from 10 to 99% at least one silane terminated polyurethane and from 1 to 90% at least one silane terminated polysiloxane; and the composition, after moisture cured, forms a surface whose water contact angle is larger than 101°. The composition is suitable for applications in coatings which afford low surface energy surface and improved mechanical performance, such as marine antifouling coating, anti-icing coating, anti-stain coating, self-cleaning coating, and non-sticky coating.

### BACKGROUND

This invention relates to one-package moisture curable compositions capable of forming polyurethane-polysiloxane-Si organic-inorganic hybrid networks having improved mechanical strength and excellent foul releasing property. The moisture curable compositions are easily applied in the field of coatings, especially in the low surface energy coating compositions, such as marine antifouling coating, anti-icing coating, anti-stain coating, self-cleaning coating, and non-sticky coating, etc.

Foul releasing coating compositions containing silicone elastomer are developed to self-clean the submerged surface and “shed” fouling microorganisms from the adhesion to the surface. Polysiloxane formulations have desired properties well known in the art, such as high thermal, UV and oxidative stability, low surface energy, hydrophobicity, and biocompatibility, among which the most commonly used polysiloxane is polydimethylsiloxane (PDMS). However, due to its low glass transition temperature, polysiloxane exhibits poor mechanical properties at room temperature, including extreme soften, low damage tolerance, easy wearing-off, and thus needs frequent reapplications.

One effective approach to improve the mechanical properties of polysiloxane based silicone coating is to blend polysiloxane with other stronger polymers such as epoxy resin or polyurethane (PU). Polysiloxanes and polyurethanes possess very different physical and mechanical properties, which have led to their widespread use in many applications. Polyurethanes stand out by virtues of mechanical strength, elasticity, adhesion resistance and abrasion resistance in the combination with polydimethylsiloxane (PDMS) in foul releasing coatings. However, uniform physical blends of polysiloxanes and polyurethanes are difficult to achieve due to the highly incompatible properties of these resins and their tendency to undergo phase separation. Moreover, simply blending PDMS with other polymers may have durability issues. Full miscibility between PDMS and PU is also not good for the formation of a foul releasing surface with phase separation and low surface energy. It will be better if PDMS-epoxy or PDMS-urethane system is crosslinked by permanent covalent bonds while still show microphase separation. In this way, a coating with good foul releasing property and a good durability can be obtained at the same time. During the curing process, phase separation might drive PDMS to the surface of the coating to form a stratified structure which accords the coating surface excellent foul releasing property and keeps outstanding mechanical properties, even at low polysiloxane concentration.

U.S. Pat. No. 6,313,335 B1 describes a thermoset PU-PDMS dispersion for foul releasing coating. The proposed coating is prepared by reacting a mixture comprising: (A) polyol; (B) polyisocyanate; (C) polyorganosiloxane having functional groups capable of reacting with the polyisocyanate. The resulting coating film shows improved mechanical and foul releasing properties. However, the polyurethane-PDMS coating is a two package thermoset system consisted of one package of polyol and hydroxyl or amino functionalized polyorganosiloxane and another package of polyisocyanate. Such two package system and the heat-curing process are not convenient in application, especially for those large surfaces which are difficult to heat-treat.

Therefore, a novel one package coating composition which lowers the raw material cost and facilitates practical application, preferably with better durability and easy crosslinking process, such as moisture curing, is still desired.

Silane terminated PU resin or polysiloxane resin are already known in sealant, adhesive or binder arts. US20050119421A1 provides a crosslinkable polymer blend suitable in the application fields of adhesives and sealants comprising a silane terminated polyurethane A having end groups of -L-CH₂—SiR¹a(OR²)₃₋ₐ, where L is a divalent linking group selected from —O—CO—NH—, —N(R³)—CO—NH—, —S—CO—NH—. The polyurethane A may be mixed with trimethylsily terminated polysiloxane serving as plasticizer and for setting the rheology of the composition. The polysiloxane lacks reactivity in the silane terminated group, resulting in no chemical bonds between the silane terminated polyurethane and the silane terminated polysiloxane after curing. Furthermore, the cured polymer blends show adhesive properties which can't be used as non-sticky or foul releasing coating.

In coating applications, the morphology of the coating surface is as important as chemical compositions. Appearance, adhesion and biocompatibility can be affected by surface topography. Because of the important role of surface morphology in interactions with biological systems, it is desirable to have a coating surface with suitable morphology features.

The inventors surprisingly found a novel one-package foul releasing composition which can be self-crosslinked in moisture condition under room temperature to form an organic-inorganic hybrid network with improved mechanical durability and excellent foul releasing performance. In this coating system, microphase separation occurred at the surface of the coating results in micro-topographical surface features during the curing process which is caused by hydrolysis and condensation of the silane end groups. The migration of polysiloxane to the coating surface forms a defined surface structure which is important for forming a surface with low surface energy that is required for foul releasing and anti-icing coatings. Domain size can be controlled by properly select silylated PU and polysiloxane with the proper type and molecular weight. Due to its low surface energy, polysiloxane will predominate on the surface. Thus, in this moisture curable PU-PDMS coating system, a special surface structure is achieved. The polysiloxane phase tends to separate away from the PU phase, while Si—O—Si covalent bonds between silylated PU and polysiloxane after hydrolysis and co-condensation of the silane group limit further macrophase separation and only allow the formation of micro-sized structures. The compatibility between silylated PU and polysiloxane is expected to play a critical role in the final morphology and properties of the foul releasing and anti-icing coatings.

Therefore, the purpose of the present invention is to provide a novel one-package moisture curable composition for PU-PDMS-Si based coating with well-defined microtopographical features and low surface energy which inhibit settlement of fouling organisms or ice, and each of release of those organisms that do settle.

### STATEMENT OF INVENTION

The present invention is directed to a one-package moisture curable composition. The composition comprises, by weight percentage based on the dry weight of the composition, from 10 to 99% at least one silane terminated polyurethane and from 1 to 90% at least one silane terminated polysiloxane, wherein the silane terminated polyurethane based polymer has at least one end group of the general formula: -A-(CH₂)ₘ—SiR¹ₙ (OR²)₃₋ₙ, where A is a urethane or urea linkage group, R¹ is selected from C₁₋₁₂ alkyl, alkenyl, alkoxy, aminoalkyl, aryl and (meth)acryloxyalkyl groups, R² is each substituted or unsubstituted C₁₋₁₈ alkyl or C₆-C₂₀ aryl groups, m is an integer from 1 to 60, and n is an integer from 0 to 1; and wherein the silane terminated polysiloxane can be a polysiloxane based polymer with hydrolysable silane group or reaction products of at least one organofunctional polysiloxane and at least one organofunctional silane; and wherein the composition, after being moisture cured, forms a surface whose water contact angle is larger than 101°.

The present invention is further directed to a low surface energy coating composition comprising the one-package moisture curable composition. The coating composition may further comprise biocides.

### DETAILED DESCRIPTION

The present invention provides a moisture curable composition by introducing silane groups into a one-package polysiloxane-polyurethane system and then hydrolyzing and co-condensing to generate Si—O—Si bonds to form an organic-inorganic hybrid network, different from the organic-organic hybrid network described in the art. With such a network, the coating film shows defined surface morphology and achieves lower surface energy and better mechanical properties.

The moisture curable composition comprises at least one silane terminated polyurethane. The term “polyurethane” herein means a resin in which the polymer units are linked by urethane or urea groups.

The silane terminated polyurethane may be prepared by reacting at least one isocyanate functionalized silane with one or more polyol(s), or reacting at least one reactive group functionalized silane with isocyanate or hydroxyl terminated prepolymer which is selected from the group consisting of polyurethanes, polyureas, polyethers, polyesters, poly(meth)acrylates, polycarbonates, polystyrenes, polyamines or polyamides, polyvinyl esters, styrene/butadiene copolymers, polyolefins, polysiloxanes, and polysiloxane-urea/urethane copolymers.

Preferably, the silane terminated polyurethane has a number average molecular weight in the range of from 500 to 100,000, more preferably from 800 to 50,000.

“Polyol” herein refers to a polymer with at least one hydroxyl group, such as, for example, natural oil polyol (NOP), polyether polyol, acrylic polyol and polyester polyol based polymers. Examples of suitable polyols include polyester polyols, polyether polyols, polycarbonate polyols, acrylic polyols, polybutadiene polyols, and polysiloxane polyols. Preferably, the polyol is selected from natural oil polyol, synthetic acrylic polyol, and the combination thereof.

Polyols suitable for the present invention include petroleum-based polyether, polyester polyols and polyols from natural resource. NOP is particularly suitable for the preparation of the composition of the present invention, due to its hydrophobic nature and good chemical resistance.

Therefore, in one preferred embodiment, the silane terminated polyurethane of the present invention come from polyols comprising at least one natural oil derived polyol having at least one hydroxyl group per molecule, which is the reaction product of reactants (a) at least one polyester polyol or fatty acid derived polyol which is the reaction product of at least one initiator and a mixture of fatty acids or derivatives of fatty acids comprising at least about 45 weight percent monounsaturated fatty acids or derivatives thereof, (b) optionally, at least one polyol which is different from the polyol of (a).

The NOP herein includes modified NOPs, such as, for example, Gen 1 NOP DWD 2080 from The Dow Chemical Company (Midland, Mich., USA), which are reconstructed NOP molecules with monomers of saturated, mono-hydroxyl, bi-hydroxyl and tri-hydroxylmethyl esters at a weight ratio of approximately 32%, 38%, 28% and 2%. In another example, Gen 4 NOP, available from The Dow Chemical Company, is obtained by reacting Unoxol™ diol (Dow) and seed oil diol monomers which are separated from seed oil monomer. The Gen 4 NOP has following structure with the hydroxyl equivalent weight of 170 g/mol.

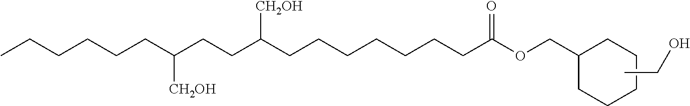

The natural oil derived polyols are polyols based on or derived from renewable feedstock resources such as natural and/or genetically modified plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. The natural product may contain at least about 85 percent by weight unsaturated fatty acids. Examples of preferred vegetable oils include, but are not limited to, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof.

Additionally, oils obtained from organisms such as algae may also be used. Examples of animal products include lard, beef tallow, fish oils and mixtures thereof. A combination of vegetable and animal based oils/fats may also be used.

Several chemistries can be used to prepare the natural oil based polyols. Such modifications of a renewable resource include, but are not limited to, for example, epoxidation, hydroxylation, ozonolysis, esterification, hydroformylation, or alkoxylation. Such modifications are commonly known in the art.

In one embodiment, the natural oil based polyols are obtained by a multi-step process wherein the animal or vegetable oils/fats are subjected to transesterification and the constituent fatty acid esters are recovered. This step is followed by reductive hydroformylations of carbon-carbon double bonds in the constituent fatty acid esters to form hydroxymethyl groups, and then forming a polyester or polyether/polyester by reaction of the hydroxymethylated fatty acid esters with an appropriate initiator compound. The multistep process results in the production of a polyol with at least a hydrophobic moiety.

The initiator for use in the multi-step process for the production of the natural oil based polyols may be any initiator used in the production of conventional petroleum-based polyols. The initiator may, for example, be selected from the group consisting of 1,3 cyclohexane dimethanol; 1,4 cyclohexane dimethanol; neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; Bis(3-aminopropyl)methylamine; ethylene diamine; diethylene triamine; 9(1)-hydroxymethyloctadecanol; 1,4-bishydroxymethylcyclohexane; 8,8-bis(hydroxymethyl)tricycle decene; DIMEROL™ alcohol (36 carbon diol available from Henkel Corporation); hydrogenated bisphenol; 9,9(10,10)-bishydroxymethyloctadecanol; 1,2,6-hexanetriol and combinations thereof. In an alternative example, the initiator may be selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixtures thereof; and combinations thereof. In another alternative example, the initiator is glycerol, trimethylopropane, pentaerythritol, sucrose, sorbitol, and/or mixtures thereof.

In one embodiment, the initiators are alkoxlyated with ethylene oxide or a mixture of ethylene oxide and at least one other alkylene oxide to give an alkoxylated initiator with a molecular weight between 100 and 500.

The average hydroxyl functionality of at least one natural oil based polyol is in the range of from 1 to 10; or in an alternative example, in the range of from 2 to 6.

The natural oil based polyol may have a number average molecular weight in the range from 100 to 3,000; for example, from 300 to 2,000; or in the alternative, from 350 to 1,500.

The NOP of the present invention may be a blend with any of the following: aliphatic and aromatic polyester polyols including caprolactone based polyester polyols, any polyester/polyether hybrid polyols, poly(tetramethylene ether glycol) based polyether polyols; polyether polyols based on ethylene oxide, propylene oxide, butylene oxide and mixtures thereof; polycarbonate polyols, polyacetal polyols, polyacrylate polyols; polyesteramide polyols; polythioether polyols; polyolefin polyols such as saturated or unsaturated polybutadiene polyols.

In a preferred embodiment of the present invention, the moisture curable composition comprises a silane terminated NOP. The backbone of the silane terminated NOP based polymer comprises one or more urethane linkages, —O—CO—NH—, and/or one or more urea linkages, —NH—CO—NH—.

The silane terminated polyurethane may be prepared by the reaction of polyol with isocyanate functionalized silane. The reaction may proceed as, for example, a NOP triol having the following structure

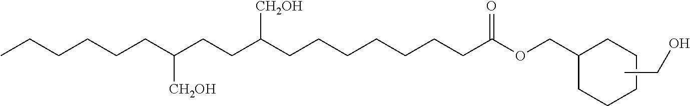

is fully silylated by isocynatopropyl triethoxysilane (IPTES) of following structure

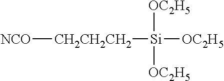

to obtain silane terminated NOP of the following structure

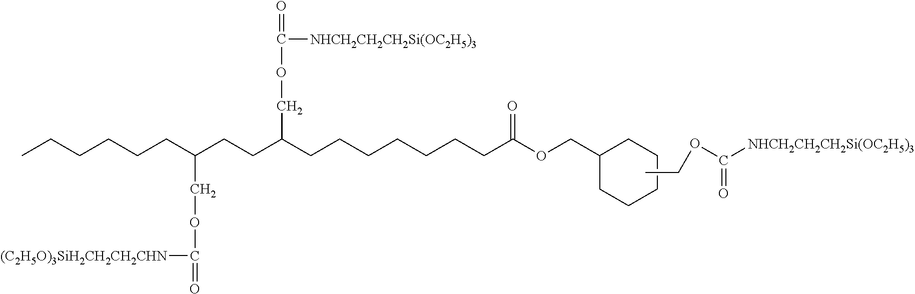

It is contemplated that isocyanate or hydroxyl terminated prepolymer resulting from the reaction of NOP and diisocyanate may be employed to replace the NOP polyol, and isocyanate functionalized silane or amino-functionalized silane can be employed according to the terminal groups of the prepolymer. If the prepolymer was terminated with isocyanate group, the amino-terminated silane will be employed. If the prepolymer was terminated with hydroxyl group, the isocyanate functionalized silane will be employed

Examples of suitable diisocyanates include such as, for example, 1,4-tetramethylene diisocyanate, 1,6-hexamethylene diisocyanate, 1,10-decamethylene diisocyanate, 1,4-cyclohexane diisocyanate, m- and p-phenylene diisocyanate, 2,6- and 2,4-tolyene diisocyanate, xylene diisocyanate, 4-chloro-1,3-phenylene diisocyanate, 4,4′-bisphenylene diisocyanate, 4,4′-methylene diphenylisocyante, 1,5-naphthylene diisocyanate, 1,5-tetrahydronaphthylene diisocyanate, 1,12-dodecyldiisocyanate, 2-methyl-1,5-pentane diisocyanate and mixtures thereof.

Examples of suitable amino-terminated silanes include such as, for example, 3-aminopropyltriethoxy silane, 3-aminopropyldimethylethoxy silane, 3-amiopropylmethyldiethoxy silane, 3-aminopropyltrimethoxy silane and mixtures thereof.

The content of the silane terminated polyurethane in the moisture curable coating is, by weight percentage based on the dry weight of the composition, from 10 to 99%, alternatively from 70 to 95%, alternatively from 70 to 90%, or alternatively from 85 to 90%.

The moisture curable coating comprises, by weight percentage based on the dry weight of the composition, from 1 to 90%, alternatively from 5 to 30%, alternatively from 10 to 30%, or alternatively from 10 to 15%, at least one silane terminated polysiloxane having the formula

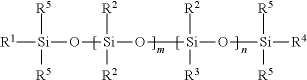

where at least one of R¹, R⁴ and R⁵ is a hydrolysable group having the formula —OR⁶, wherein R⁶ is a C₁-C₄ alkyl or C₆-C₂₀ aryl group, each of R² is independently a C₁-C₄ alkyl or a C₆-C₂₀ aryl, and R³ is a C₁-C₄ alkyl or a C₆-C₂₀ aryl or a substituted or unsubstituted C₁ to C₆₀ hydrocarbon radical, each of m and n is independently an integer from 0 to 1,500, preferably from about 5 to about 500, and more preferable from about 10 to about 300, and m+n≧2.

The silane terminated polysiloxane may be the reaction products of reactants

(a) an organofunctional polysiloxane of the general formula

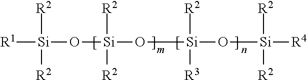

wherein at least one of R¹, R³ and R⁴ has at least one reactive functional X group selected from, but not limited to, carbinol, amino, isocyanate, epoxy, maleic anhydride, thiol, acrylic, and vinyl groups, R² is a C₁-C₄ alkyl or C₆-C₂₀ aryl, each of m and n is independently an integer from 0 to 1,500, preferable from about 5 to about 500, and more preferable from about 10 to about 300, and m+n≧2; and

(b) an organofunctional silane having at least one reactive functional Y group selected from, but not limited to, hydroxyl, amino, isocyanate, epoxy, maleic anhydride, thiol, acrylic and vinyl groups whichever is capable of reacting with the X group.

The X group and the Y group are chemically reactive with each other, for instance, when X is a carbinol group, the Y could be an isocyanate group. The back bone of silane terminated polysiloxane, or preferable PDMS, may comprise one or more linkages, which would be urethane linkages (—O—CO—NH—) if X is a carbinol group and Y is an isocyanate group, or urea linkages (—NH—CO—NH—) if X is an isocyanate group and Y is an amino group, or the following linkages if the X is an epoxy group and Y is an amino group.

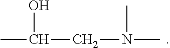

In one preferred embodiment, at least one of R¹, R³ and R⁴ has at least one group selected from carbinol, amino, epoxy, vinyl and acrylic.

The polysiloxane of the present invention, typically, is well known components of coating compositions in the art. Examples of suitable polysiloxane include polysiloxane derivatives such as, for example, polydimethylsiloxane, polydiethylsiloxane and mixtures thereof.

Examples of suitable silane terminated polysiloxane also include commercially available polysiloxane products with terminal hydrolytic silane group containing, for example, Si—OCH₃, Si—OC₂H₅, Si—OC₃H₆, or by reacting an organofunctionalized polysiloxane with an organofunctionalized silane. For example, PDMS with the below structure

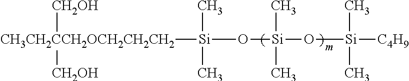

is fully silylated by IPTES to obtain silane terminated PDMS of the following structure

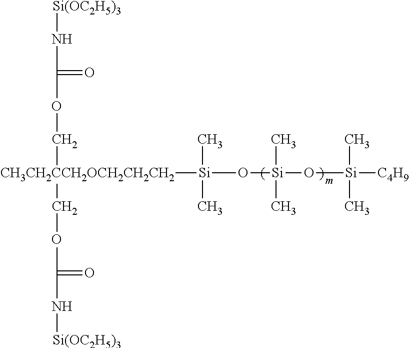

Preferably, the organofunctional polysiloxane has a number average molecular weight in the range of from 500 to 200,000, more preferably from 1,000 to 50,000.

More preferably, organofunctional polysiloxanes have organiofunctional groups on one side, instead of on two sides of the polysiloxane chain. Therefore, after it is incorporated into the hybrid network of the coating, polysiloxane can pend to the main chain of the network to form a comb structure.

In one embodiment, a carbinol functionalized polysiloxane is used to react with isocyanate functionalized silane. The carbinol functionalized polysiloxane used herein may have a hydroxyl group at one chain end, or two hydroxyl groups at one end or at both ends, or at the side chains of polysiloxane. Isocyanate functionalized silane is capable of reacting with hydroxyl groups. Suitable isocyanate functionalized silanes include, but are not limited to, isocyanatopropyl triethoxysilane, isocyanatopropyl triemethoxysilane, isocyanatomethyl methyldiethoxysilane, isocyanatomethyl methyldimethoxysilane and mixtures thereof.

In one embodiment of the present invention, the moisture curable composition may further comprise, by weight based on the dry weight of the composition, up to 50%, alternatively up to 30%, or alternatively up to 20%, an alkoxysilane additive other than aforementioned polysiloxanes. The alkoxysilane introduced to the composition may participate in moisture curing reaction at room temperature, due to the hydrolytic groups of the alkoxysilane. The alkoxysilane used herein includes the below general formulae

R¹ₘSi(OR²)₄₋ₘ

wherein R¹ is independently a C₁-C₁₈ alkyl and/or C₆-C₂₀ aryl chain, R² is C₁-C₁₂ alkyl chain or aryl groups and (OR²) group is a hydrolytic group, m is an integer from 0 to 1. Alkoxysilane used herein can be, for example, hexadecyltrimethoxysilane, octyltriethoxysilane, propyltriethoxysilane or tetraethoxysilane (TEOS).

The silylated polymers have silane group at the end of the molecular chain. The end group of silylated polymers can have the general formula:

-A-(CH₂)ₘ—SiR¹ₙ(OR²)₃₋ₙ,

where A is a functional linkage group, for example, including but not limited, urethane or urea group; R¹ may be a C₁₋₁₂ alkyl, alkenyl, alkoxy, aminoalkyl or aryl group or a (meth)acryloxyalkyl group; R² is each substituted or unsubstitured C₁₋₁₈ alkyl or C₆-C₂₀ aryl groups; m is an integer from 1 to 60; n is an integer from 0 to 1.

In one preferred embodiment of the present invention the moisture curable composition comprises, by weight based on the dry weight of the composition, from 10 to 99%, at least one silane terminated polyurethane and, from 1 to 90%, at least one silane terminated polysiloxane.

The summation of the components' percentage in the moisture curable composition is 100%. When there is a selective component increase in the composition, other components may reduce their percentage by lowering their upper limit.

The term “up to” in a range means any and all amounts greater than zero and through to and including the end point of the range.

In one preferred embodiment, the average molecular weight of silane terminated PU ranges from 500 to 100,000 and the average molecular weight of polysiloxane ranges from 500 to 200,000. Within these ranges, the phase separation of PU and polysiloxane effectively occurs during the curing process. With increasing molecular weight, in general, the compatibility between PU and polysiloxane decreases and phase size becomes larger.

The moisture curable composition of the present invention is substantially free of water. “Substantially free of water” herein means the water contained in the composition is not sufficient to initiate a moisture curing process of the composition.

The present invention provides low surface energy coating compositions comprising the aforementioned moisture curable composition. The coating composition may further comprise hydrophobic agents conventionally used in the art to form a hydrophobic foul releasing surface. Suitable hydrophobic agents include, for example, Si-based hydrophobic agents such as siloxane, silane and silicone; fluoro-based hydrophobic agents such as fluorosilanes, fluoroalkyl silanes, polytetrafluoroethylene, polytrifluoroethylene, polyvinylfluoride, and functional fluoroalkyl compounds; and hydrocarbon hydrophobic agents such as reactive wax, polyethylene, or polypropylene. Other additives, when in appropriate concentrations, may be incorporated into the low surface energy coating composition without substantially sacrifice other properties such as mechanical strength or durability. The coating composition may further comprise additives including colorants, pigments and fillers, antioxidants, UV stabilizers, biocides, thickeners and viscosity enhancers, in amounts generally used, according to application requirement.

The biocides can be used in the low surface energy coating composition of the present invention are organic or inorganic biocides. Example are described in U.S. Pat. No. 4,127,687 to Dupont, in U.S. Pat. No. 4,898,895 to Masuoka et al, and in WO1995032862A1. Preferably, the biocide(s) is with the active structure of Diiodomethyl-p-tolylsulfone, 4,5-Dichloro-2-octyl-2H-isothiazol-3-one (DCOIT). Commercial biocides products are Dow Chemical Co. product under the trademark SEA-NINE™211 having the active structure of DCOIT, and Dow Chemical Co. product under the trademark AMICAL™48 having the active structure of Diiodomethyl-p-tolylsulfone. DCOIT can also be combined with Zineb, having the active structure of Zinc-ethylenebis(dithiocarbamate), for a better performance.

Where such biocides are used, they are preferably used in amounts of from 1-20 wt. % based on the dry weight of the coating composition, more preferably is from 1 to 15 wt. %, most preferably, is from 1 to 10 wt. %.

The low surface energy coating composition, in addition to the silane terminated polyurethane and the silane terminated polysiloxane of the moisture curable composition described herein, may also contain one or more additional polymeric binders such as, for example, epoxy, and acrylic polymer.

The low surface energy coating composition is prepared with techniques which are well known in the coating art. First, optionally, pigments, fillers, and additives can be used in the coating. Addition of such materials, physical properties, such as viscosity, flow rate, sag, and like and mechanical properties such as modulus, hardness, impact resistance and the like can be modified. However, to prevent premature hydrolysis of the moisture sensitive groups of the polymers, the fillers and pigments should be thoroughly dried before admixing. Exemplary filler materials such as calcium carbonate, fumed silica, precipitated silica, magnesium carbonate, talc, and the like. Exemplary pigments such as titanium dioxide, iron oxides, carbon black and the like. The fillers and pigments may be used singly or in combination. This list is not comprehensive and is given as illustrative. In addition to fillers and pigments, additives such as moisture scavengers, adhesion promoters, and the like can also be used. They are well dispersed in coating formulations under high shear such as is afforded by a mixer or, in the alternative, at least one predispersed pigment may be used.

The solid content of the low surface energy coating composition may be from about 50% to about 80% by volume in at least on solvent. To prevent premature hydrolysis of the moisture sensitive groups a suitable aprotic solvent that will dissolve or disperse the silane terminated polyurethane and polydimethylsiloxane polymers is used. The solvent is used to adjust the viscosity to match the desired coating application method. A single solvent can be used; however in other cases it is often desirable to use mixtures of solvents in order to effect the best solubilization. Examples of oxygentated solvents include acetone, methyl ethyl ketone, methyl isobutyl ketone, methyl amyl ketone; propylene glycol monomethyl ether acetate, propylene glycol propyl ether acetate, ethoxypropionate, dipropylene glycol monomethyl ether acetate, propylene glycol monomethyl ether, propylene glycol monopropyl ether, dibasic ester (a mixture of esters of dibasic acids marketed by DuPont), butyl acetate, isobutyl acetate, amyl acetate, isoamyl acetate, mixtures of hexyl acetates, such as those sold by Exxon Chemical Company under the brand Exxate 700, aromatic solvents include toluene, xylene, and solvents which are narrow cut aromatic solvents comprising C₈ to C₁₃ aromatics such as those marketed by Exxon under the trade designation Aromatic™100, Aromatic™150, and Aromatic™ 200. Isoparaffinic solvents such as those marketed by Exxon under the trade designation Isopar™. The list should not be considered as limiting, but ration as examples of solvents which are useful in the present invention. The type and concentration of solvents are generally selected to obtain formulation viscosities and evaporation rates suitable for the application and cure of the coating. The moisture curable composition and the coating composition prepared therefrom are stable compositions in non-water conditions and can be in the form of one-package products for storage, transportation and application.

The methods for preparation of the moisture curable composition of the present invention comprises different ways, for example, (i) silylating polyurethane based polymer and the polysiloxane based polymer separately, and then mixing the silane terminated polyurethane based polymer and the silane terminated polysiloxane based polymer, or (ii) silylating a mixture of the polyurethane based polymer and the polysiloxane based polymer. The moisture curable composition and the coating composition prepared therefrom can both be self-cured by moisture at room temperature. In one example, the blending of the silane terminated NOP based PU and the silane terminated PDMS mixture can be achieved by reacting the NOP and carbinol terminated PDMS mixture with an isocyanate functionalized organosilane. In an alternative example, NOP can also be silynated solely, and then mixed with a silane terminated PDMS to obtain a crosslinkable coating system. Theoretically, the silane terminated polysiloxane has a certain degree of compatibility with the silane terminated polyurethane. The polysiloxane is prone to be covalently bonded with polyurethane by hydrolysis and co-condensation of the silane group. In a hypothesis but not to limit the invention, the inventors believe that in the present invention, due to the hydrolysis and co-condensation of silane groups of the silane terminated polyurethane and the silane terminated polysiloxane, Si—O—Si bonds are generated and thus resulting in a crosslinked organic-inorganic hybrid network. The Si—O—Si inorganic bonds strengthen the hybrid network and offer improved mechanical performance. Moreover, the inventors believe that, with appropriate molecular weight, the polysiloxane component migrates to the surface of the coating film, due to the surface energy driving force. Such migration offers the coating film surface with low surface energy. Meanwhile, polyurethane segments provide good adhesion to the substrate or primer coating and also contribute to the outstanding mechanical properties.

The low surface energy coating composition may be applied by conventional application methods such as, for example, brushing, roller application, and spraying methods such as, for example, air-atomized spray, air-assisted spray, airless spray, high volume low pressure spray, and air-assisted airless spray.

The low surface energy coating composition may be applied to a substrate such as, for example, metal, plastic, wood, stone, glass, fabric, concrete, primed surfaces, previously painted surfaces, and cementitious substrates.

In one embodiment, the coatings are multi-layer coatings comprising the coating compositions of the present invention as a topcoat, a base coat, and, optionally, a tie coat.

The low surface energy coating composition of the present invention can be used in applications including, but not limited to, marine antifouling coating, anti-icing coating, anti-stain coating, self-cleaning coating, or non-sticky coating, etc. Organisms, dirt, and ice are not easily adhere to the coating film of the present invention.

The coating composition coated on the substrate is dried, or allowed to dry, at a temperature of from 1° C. to 95° C., typically at room temperature.

The surface energy of the coating film surface is tested to indicate the foul-releasing property of the low surface energy coating composition. The adhesion strength of organisms such as barnacles to the coating surface generally relates to the surface energy of the coatings. Usually organisms have low adhesion strength to a surface with low surface energy. A generic parameter which reflects the surface energy of the coating is the water static contact angle. A water droplet on the surface with low surface energy will show a very high static contact angle. For the foul releasing coating application, it is desirable if the water static contact angle is larger than 101°. A silane terminated polysiloxane shows good hydrophobicity in nature and tends to predominate on the surface of coatings because of the surface energy driving force. The coating film formed from the coating composition of the present invention is believed to comprise predominantly a bottom layer of tough polyurethane, Si—O—Si crosslinked networks, and a top layer of polysiloxane with low surface energy, all of which are favorable for durable foul releasing applications.

The advantages of the PU-PDMS-Si hybrid system of the present invention include the capablity of being produced, stored and transported in one-package form, moisture curability at room temperature, low toxicity (no free isocyanate), environmental benignness, excellent film forming properties, improved mechanical performance, and excellent foul releasing property.

In the present specification, the technical features in each preferred technical solution and more preferred technical solution can be combined with each other to form new technical solutions unless indicated otherwise. For brevity, the applicant omits descriptions of these combinations. However, all the technical solutions obtained by combining these technical features should be deemed as being literally described in the present specification in an explicit manner.

### EXAMPLES

### I. Raw Materials

Material used in the coating compositions

| Material | Function | Chemical nature | Supplier |
|---|---|---|---|
| IPTES | Silane | Isocyanatopropyl | TCI |
| | | triethoxysilane | |
| APTES | Silane | 3- | Aldrich |
| | | aminopropyltriethoxysilane | |
| DBTDL | Catalyst | dibutyltin dilaurate | Sinopharm |
| | | | Chemical |
| | | | Reagent |
| | | | Company |
| HDI | di-isocyanate | 1,6-hexamethylene | TCI |
| | | diisocyanate | |
| p-toluenesulfonic acid | Catalyst | p-toluenesulfonic acid | Sinopharm |
| | | | Chemical |
| | | | Reagent |
| | | | Company |
| Desmodur N 3300 | HDI trimer | HDI trimer | Bayer |
| DWD 2080 | NOP polyol | Gen 1 NOP | Dow |
| | | | Chemical |
| NOP 1 | NOP polyol | Gen 4 NOP with | Dow |
| | | HEW = 170 g/mol and Fn = 3 | Chemical |
| NOP2 | NOP polyol | Gen 4 NOP with | Dow |
| | | HEW = 350 g/mol and | Chemical |
| | | Fn = 2.4 | |
| VORANOL ™ WD | Polyether | Polyether polyol | Dow |
| 2104 | polyol | | Chemical |
| VORANOL ™ 2100-TB | Polyether | Polyether polyol | Dow |
| | polyol | | Chemical |
| VORANOL ™ CP 1055 | Polyether | Polyether polyol | Dow |
| | polyol | | Chemical |
| Joncryl 922 | Acrylic polyol | Acrylic Polyol | UNIQEMA |
| Capa 3050 | Polyester | Polyester polyol | PERSTOR |
| | polyol | | P UK |
| | | | Limited |
| MCR-C61 | PDMS | Dicarbinol | Gelest |
| | | Polydimethylsiloxane with | |
| | | HEW = 500 and Fn = 2 | |
| MCR-C62 | PDMS | Dicarbinol | Gelest |
| | | Polydimethylsiloxane with | |
| | | HEW = 2500 and Fn = 2 | |
| Silmer OH Di-10 | PDMS | Dicarbinol | Sil TECH |
| | | Polydimethylsiloxane with | Company |
| | | HEW = 3500 and Fn = 2 | |
| Butyl acetate | Solvent | Butyl acetate | Eastman |
| T5650E | Polycarbonate | HEW: 250.6 | Ashai- |
| | polyol | Fn: 2 | Kasei |
| T5650J | Polycarbonate | HEW: 392 | Ashai- |
| | polyol | Fn: 2 | Kasei |
| T3452 | Polycarbonate | EW: 1000 | Ashai- |
| | polyol | Fn: 2 | Kasei |
| IPTMS | Silane | Isocyanatopropyl | Momentive |
| | | Triethoxysilane | |
| Dibutoxyl dibutyl tin | Catalyst | Dibutoxyl dibutyl tin | Gelest |
| Dimethylhydroxyoleate | Catalyst | Dimethylhydroxyoleate tin | Gelest |
| tin | | | |
| Seanine 211 | Biocide | 4,5-dichloro-2-n-octyl-4- | Dow |
| | | isothiazolin-3-one, 30% in | Chemical |
| | | mixed xylenes | |
| Amical 48 | Biocide | Diiodomethyl p- | Dow |
| | | tolylsulfone, 95% | Chemical |
| | | Iodomethyl p-tolysulfone, | |
| | | 2-3% | |
| | | Fumed silica (generic), 1-2% | |
| | | p-toluenesulfonic acid, 0.2-1% | |
| | | Water, 0.1-1% | |

### II. Test Procedures

### Pseudo-Barnacle Pull Off Strength Test

The test was carried out according to a modified procedure as described in reference (Kohl JG& Singer IL, Pull-off behavior of epoxy bonded to silicone duplex coatings, Progress in Organic Coatings, 1999, 36:15-20) using an Elcometer™ pull off strength tester.

Ten-millimeter diameter aluminum studs were designed specially for the Elcometer™ instrument. The epoxy adhesive (Araldite™ resin) was used to glue the studs to the surface of the coated panels. The excessive epoxy was trimmed after about one hour cure. The epoxy adhesive was then allowed to harden for three days at room temperature. The stud was then pulled off by the Elcometer™ instrument till the stud detached from the coating surface. For each test, at least three replicate samples were employed and the average value for pull off strength (MPa) was recorded. The threshold of pseudo-barnacle pull off strength was 0.5 MPa. When it was lower than 0.5 MPa, the coating exhibited good foul releasing property.

### Mechanical Tests

Pencil hardness of the coated surface was evaluated following ASTM D 3363 specifications using a pencil with a grade of such as 6B-6H. The impact resistance is measured in accordance with ASTM D 2794-93. The coated panel was placed under a 2-lb load which has a round tip with a diameter of 0.5 inch. The load was lifted to a certain height and then dropped to generate an impact on the coating and the steel panel. When the height of the lifted load was higher than a certain value, the coating would be damaged by the impact generated by the dropping load. The value of cm/lbs was recorded to evaluate the impact resistance performance of the coating. Damage tolerance was tested by fingernail scratch and diamond cone damage. The results were evaluated by the appearance of the coatings after fingernail scratch or diamond cone damage with the naked eye and microscopy. The damage tolerance was rated “G (good)” when no scratching on the coating surface or slight damage by diamond cone or “NG (no good)” when the coating surface was seriously damaged by fingernail scratch or diamond cone.

### Algae Resistance Test

Laboratory bioassays of algae for the coatings were also carried out. The antifouling performance of the coatings was evaluated in lab with respect to the attachment of diatom Navicula (purchased from Institute of Hydrobiology, Chinese Academy of Science) during its exponential growth phase in static condition. Diatom cells were introduced into sterile conical flasks with culture medium and incubated under regular illumination (12 hours light:12 hours dark) at 25° C., 90% humidity over 21 consecutive days. Cell growth was estimated daily by direct counting of the cells with blood counting chamber. After three weeks incubation, the cell concentration reached to about 107 cell/ml. Then part of the cell suspension was removed from the flask and was used for the antifouling performance test. All test panels were dipped into the prepared cell suspension respectively and incubated under same culture condition. After being immersed for different periods of time, the testing panels were taken out of the diatom cell suspension and observed. Images were recorded and used to compare the antifouling performance of different coatings. The tested coatings was observed by eye and represented by alage accumulation No. shown in Table 1.

TABLE 1
Alage accumulation

| Score | State |
|---|---|
| 5 | very serious algae adhesion |
| 4 | serious algae adhesion |
| 3 | lots of algae adhesion |
| 2 | moderate algae adhesion |
| 1 | little algae adhesion |
| 0 | no algae adhesion |

### Ice Adhesion Strength Test

To test the capability of the moisture cured PU-PDMS coatings on reducing the adhesion strength of ice, an ice adhesion strength measurement was conducted according to the method described below.

A plastic ring with radius of 2.5 cm was placed on the coated or uncoated surface. The ring on the layer was introduced into a constant temperature freezer at −20° C. and cooled for three hours. 20 ml water was poured into the inside of the ring and the apparatus was then placed in the freezer at −20° C. for 24 h to form an ice cylinder on the surface of the coating. The ice cylinder was pushed to detach from the coating layer and the maximum force was record by a dynamometer.

### Example 1

3.4 g of Gen 4 polyol NOP1 with hydroxyl equivalent weight of 170 g/mol and 0.93 g carbinol terminated PDMS (MCR-C62 with hydroxyl equivalent weight of 2500 g/mol) were introduced into a 250 mL round bottom flask equipped with a mechanical stirrer. 5.3 g of isocyanatopropyl triethoxysilane (IPTES, 95% grade) and 4 g butyl acetate (AR grade) were added into the round bottom flask. The mixture was stirred at 75° C. under nitrogen protection. 0.1 wt % of catalyst dibutyltin dilaurate (DBTDL) (AR grade) was added. The reaction was allowed to proceed until complete disappearance of isocyanate functional groups, which was confirmed by IR analysis.

5 g of silane functionalized NOP/PDMS solution (70% solid) was mixed with 0.2 wt % p-toluenesulfonic acid. The solution was then stirred for 20 minutes. The thoroughly mixed solution was removed from the mixer and allowed to stay static for 2-5 minutes to remove most of the gas bubbles. The above formulation was coated using blade coater on an aluminum panel. A wet coating with the thickness of 300 μm was applied to clean aluminum panels (H. J. Unkel Co., Ltd.). The coated panels were allowed to dry at room temperature for at least 2 days prior to contact angle measurements and pseudo-barnacle pull off strength test. Contact angles were measured using an OCA 20 contact angle instrument (DataPhysics Company). A coating surface with good foul releasing property typically exhibits static contact angles equal to or higher than 101°. The pseudo-barnacle pull off test indicated that a coating surface with good foul releasing property typically exhibits pseudo-barnacle pull off strength lower than 0.5 MPa.

The formulations of the moisture curable PU-PDMS-Si coatings were listed in Table 2. In all formulations, IPTES was used as functionalized silane to terminate the NOP and dicarbinol PDMS. MCR-C61, MCR-C62 and Silmer OH Di-100 were employed as dicarbinol PDMS in the formulation.

TABLE 2
Moisture curable PU-PDMS-Si coating compositions

| | | | | | | Pseudo- |
|---|---|---|---|---|---|---|
| | | | | | | barnacle |
| | | Silylated | | Silylated | Contact | pull off |
| Coating | | PU | | PDMS | angle | strength |
| Sample | Polyol | (solid wt %) | PDMS | (solid wt %) | (°) | (MPa) |
| 1 | NOP1 | 90 | MCR-C62 | 10 | 109 | <0.2 |
| 2 | NOP1 | 95 | MCR-C62 | 5 | 101 | 0.4 |
| 3 | NOP1 | 98 | MCR-C62 | 2 | 101 | 0.4 |
| 4 | NOP1 | 85 | MCR-C62 | 15 | 109 | <0.2 |
| 5 | NOP1 | 70 | MCR-C62 | 30 | 107 | 0.4 |
| 6 | NOP2 | 90 | MCR-C62 | 10 | 108 | 0.2 |
| | | | 0.6 g | | | |
| 7 | DWD 2080 | 90 | MCR-C62 | 10 | 108 | 0.2 |
| 8 | NOP 1 | 90 | MCR-C61 | 10 | 105 | 0.3 |
| 9 | NOP 1 | 70 | MCR-C61 | 30 | 104 | 0.4 |
| 10 | NOP 1 | 30 | MCR-C61 | 70 | 105 | 0.4 |
| 11 | NOP2 | 90 | MCR-C61 | 10 | 104 | 0.3 |
| | | | 0.6 g | | | |
| 12 | DWD 2080 | 90 | MCR-C61 | 10 | 110 | 0.3 |
| | | | 0.75 g | | | |
| 13 | VORANOL | 90 | MCR-C62 | 10 | 107 | 0.2 |
| | WD 2104 | | 0.45 g | | | |
| 14 | VORANOL | 90 | MCR-C61 | 10 | 103 | 0.4 |
| | WD 2104 | | 0.45 g | | | |
| 15 | VORANOL | 90 | MCR-C62 | 10 | 106 | 0.2 |
| | 2100-TB | | 0.75 g | | | |
| 16 | VORANOL | 90 | MCR-C61 | 10 | 101 | 0.4 |
| | 2100-TB | | 0.75 g | | | |
| 17 | VORANOL | 90 | MCR-C62 | 10 | 109 | 0.3 |
| | CP 1055 | | 0.58 g | | | |
| 18 | Joncryl | 90 | MCR-C62 | 10 | 112 | 0.2 |
| | 922 | | 0.65 g | | | |
| 19 | Capa 3050 | 90 | MCR-C62 | 10 | 107 | 0.3 |
| | | | 0.56 g | | | |
| 20 | NOP 1 | 90 | Silmer OH | 10 | 106 | 0.2-0.3 |
| | | | Di-100 | | | |
| 21 | NOP 2 | 90 | Silmer OH | 10 | 105 | 0.3 |
| | | | Di-100 | | | |
| ^{a} Comp. | NOP1 | 100 | N/A | 0 | 87 | >2.7 |
| Sample 1 | | | | | | |

| | | | | | |
|---|---|---|---|---|---|
| ^{b} Comp. | N/A | 0 | Pure PDMS coating | 105 | 0.2 |
| Sample 2 | | | | | |
| ^{c} Comp. | N/A | 0 | 2 Package | 107 | 0.2 |
| Sample 3 | | | PU-PDMS coating | | |

^{a} Comparative sample 1 was a pure silylated PU coating, which showed poor foul releasing property.
^{b} Comparative sample 2 was a pure PDMS coating, which showed good foul releasing property while the mechanical strength was poor so that the surface was easily damaged by finger scratch.
^{c} Comparative sample 3 was a two-package PU-PDMS coating prepared according to U.S. patent application No. 20070129528 with the following procedure: NOP, PDMS, solvents, and catalyst were put in a one ounce glass jar with a magnetic stir bar. The solution was mixed at room temperature for 10 minutes. Then HDI trimer was added to the mixture. The mixture was stirred for 20 minutes and then coated on aluminum panel as described above in Example 1.

Compared with comparative sample 2 (the pure PDMS coating), moisture curable PU-PDMS-Si coating samples in this invention showed comparable foul releasing properties, and exhibited improved mechanical properties in mechanical test.

TABLE 3
Result of mechanical tests

| | | Impact resistance | |
|---|---|---|---|
| Coating sample | Hardness | (cm/lbs) | Damage tolerance |
| 1 | 4H | 30 | G |
| 3 | 3H | 40 | G |
| 6 | 3H | 60 | G |
| 7 | HB | 100 | G |
| Comp. Sample 2 | <4B | 100 | NG |
| Comp. Sample 3 | 4H | 50 | G |

Compared with comparative sample 3 (the two-package PU-PDMS coating), tested samples 1, 3, 6 and 7 (inventive one-package moisture curable PU-PDMS coating) showed advantages including moisture curability under room temperature, excellent film forming properties, improved mechanical performance, comparable foul releasing property, and ease of coating operation.

### Example 2

In this example, silane terminated PU and silane terminated PDMS were synthesized separately, and then mixed together to get a moisture curable foul releasing coating composition.

3.4 g of Gen 4 polyol NOP1 was introduced to a 50 mL round bottom flask equipped with a mechanical stirrer. 5.2 g of IPTES and 3.7 g butyl acetate were added to the round bottom flask. The mixture was stirred at 75° C. under nitrogen protection. 0.1 wt % of catalyst DBTDL was added. The reaction was allowed to proceed until complete disappearance of isocyanate functional groups, which was confirmed by IR analysis.

25 g MCR-C62 was introduced to a 100 mL round bottom flask equipped with a mechanical stirrer. 2.6 g of IPTES were added into the round bottom flask. The mixture was stirred at 75° C. under nitrogen protection. 0.1 wt % of catalyst DBTDL was added. The reaction was allowed to proceed until complete disappearance of isocyanate functional groups, which was confirmed by IR analysis.

10 g of silane terminated NOP solution (70% solid) and 0.7 g silane terminated PDMS were mixed with 0.2 wt % p-toluenesulfonic acid and stirred for 20 minutes. The coating was prepared in the same way as Example 1. The water contact angle of the coating was 109° and the pseudo-barnacle pull off test result was lower than 0.2 MPa.

### Example 3

In this example, silane terminated PU and silane terminated PDMS were synthesized separately, and then mixed together to get a moisture curable foul releasing coating composition. The polyols are polycarbonate polyols from Ashai-Kasei. Either the isocyanatopropyl triethoxysilane (IPTES, 95% grade) or isocyanatopropyl trimethoxysilane (IPTMS, 95% grade) were used to synthesized the silane terminated PU. Catalysts used to cure the coatings can be 0.2 wt % p-toluenesulfonic acid, pure dibutoxyldibutyl tin, or pure dimethylhydroxyoleate tin.

0.2 mol of polycarbonate polyol was introduced to a 50 mL round bottom flask equipped with a mechanical stirrer. 0.2 mol of IPTES or IPTMS were added to the round bottom flask. Then, butyl acetate was added to make 70% solid solution. The mixture was stirred at 75° C. under nitrogen protection. 0.1 wt % of catalyst DBTDL was added. The reaction was allowed to proceed until entire disappearance of isocyanate functional groups, which was confirmed by IR analysis.

0.01 mol of MCR-C62 was introduced to a 100 mL round bottom flask equipped with a mechanical stirrer. 0.01 mol of IPTES or IPTMS were added to the round bottom flask. The mixture was stirred at 75° C. under nitrogen protection. 0.1 wt % of catalyst DBTDL was added. The reaction was allowed to proceed until entire disappearance of isocyanate functional groups, which was confirmed by IR analysis.

10 g of silane terminated PU solution (70% solid) and 0.7 g silane terminated PDMS were mixed with catalyst and stirred for 20 minutes. The coating was prepared in the same way as Example 1. See Table 4 for the coating composition and the characterized properties.

TABLE 4
Coating composition and properties

| | | | | | | Pseudo- |
|---|---|---|---|---|---|---|
| | | | | | | barnacle |
| | | | | Catalyst | Surface | pull off |
| Coating | | | Catalyst | level based | Energy | strength |
| sample | Polyol Silane | PDMS Silane | type | on solid | (mJ/m2) | (Mpa) |
| 22 | T5650E/IPTES | MCR62/IPTES | 0.2 wt % PTSA | 7% | 27.1 | 0.02 |
| 23 | T5650J/IPTES | MCR62/IPTES | 0.2 wt % PTSA | 7% | 25.34 | 0.05 |
| 24 | G3452/IPTES | MCR62/IPTES | 0.2 wt % PTSA | 7% | 21.2 | 0.19 |
| 25 | G3452/IPTES | MCR62/IPTES | Dibutoxyl | 2% | 22.0 | 0.16 |
| | | | dibutyl tin | | | |
| 26 | G5650E/IPTMS | MCR62/IPTMS | Dimethyl | 0.2% | 20.2 | 0.07 |
| | | | hydroxyoleate tin | | | |

### Example 4

A reaction is carried out between polyol-diPDMS and an excess of diisocyanate with molar ratio of NCO/OH=2. The isocyanate terminated polyurethane prepolymer can react with amino functional silane to get a silane terminated PU-PDMS prepolymer.

20 g of VORANOL WD 2104 and 2 g of dicarbinol PDMS MCR-C62 was introduced to a 250 ml round bottom flask equipped with a mechanical stirrer. 22.4 g of IPDI were added to the round bottom flask. 0.1 wt % of catalyst DBTDL was added. The mixture was stirred at 75° C. under nitrogen protection for 1 h. After cool to room temperature, 41.9 g of butyl acetate was added. 20.5 g of APTES was carefully added in the flask without contacting with air, and the reaction was conducted under room temperature for at least 30 min under vigorous stirring. The results silylated PU-PDMS copolymer solution B was stored for use.

25 g of MCR-C62 was introduced into a 50 mL round bottom flask equipped with a mechanical stirrer. 2.63 g of IPTES was added into the round bottom flask. The mixture was stirred at 75° C. under nitrogen protection. 0.1 wt % of DBTDL was added. The reaction was allowed to proceed until complete disappearance of isocyanate functional groups, which was confirmed by IR analysis. This silylated PDMS materials C was stored for use.

5 g of silylated PU-PDMS copolymer solution B (60% solid) was mixed with 0.3 g of silylated PDMS materials C to get a PU-PDMS-Si solution D, and then mixed with 0.2 wt % p-toluenesulfonic acid. The solution was then mixed for 20 minutes. The coating was prepared in the same way as Example 1. The contact angle of the coating was stable at around 109° and the pseudo-barnacle pull off strength is less than 0.2 MPa. The impact resistance is larger than 200 cm/lbs.

### Example 5

Coating sample 27: 5 g of silane functionalized PU-PDMS-Si solution (70% solid, as described in Example 1) and 1.185 g Amical 48 solution (0.185 g of Amical 48 dissolved in 1 g methyl ethyl ketone) were mixed with stirring. 0.2 wt % p-toluenesulfonic acid was then added. The mixture was stirred for 20 minutes. The coating was prepared in the same way as Example 1. The Pseudo-barnacle pull off strength is less than 0.1 MPa.

Coating sample 28: 5 g of silane functionalized PU-PDMS-Si solution (70% solid, as described in Example 1) and 0.6 g Seanine-211 solution (30%) were mixed with stirring. 0.2 wt % p-toluenesulfonic acid was then added. The mixture was stirred for 20 minutes. The coating was prepared in the same way as Example 1. The Pseudo-barnacle pull off strength is less than 0.1 MPa.

TABLE 5
Coating properties from the examples

| | | Content | Pseudo- | | |
|---|---|---|---|---|---|
| | | of | barnacle pull | Contact | |
| Coating | | Biocides | off strength | angle | Alage |
| sample | Biocides | (wt %) | (Mpa) | (°) | accumulation |
| 1 | None | 0 | ≦0.1 | 106 | 4 |
| 27 | Amical 48 | 5 | ≦0.1 | 105 | 1 |
| 28 | Seanine 211 | 5 | ≦0.1 | 107 | 1 |

The coating properties of the examples have been summarized in Table 5. With the blending of various biocides into PU-PDMS-Si system, all the coatings have good mechanical properties without losing their foul-release function. In addition, the coatings were very hydrophobic with contact angle ≧105 degree. Furthermore, the results of biocide-blended coatings from the laboratory screen for the accumulation of algae showed significant advantage in comparison to the control coating. After being immersed in diatom cell suspension with high biomass for 8 days, the panel of comparative example was already adhered by many navicula cells on the surface (score 4). However, the coating with blending of Amical 48 and Seanine 211 showed very good resistance to the biofilm accumulation with the score only 1.

### Example 6

Ice adhesion test was conducted for the inventive coating sample and comparative coating sample, and the results were listed in the table 6. The results show that moisture curable PU-PDMS-Si coatings have excellent ice releasing performance.

TABLE 6
Ice releasing properties of coatings

| | | | Ice adhesion |
|---|---|---|---|
| | | Contact angle | strength |
| Coating sample | Company/Producer | (°) | (N/cm²) |
| 1 | Dow Chemical | 109 | <0.005 |
| 29 | Dow Chemical | 109 | <0.005 |
| Comparative | Wearlon F-1 of | 112 | 0.599 |
| sample 4 | Wearlon Company | | |
| Comparative | PRTV-2 of | 114 | 0.879 |
| sample 5 | Hebei Gui Gu Company | | |
| Comparative | Bare Al panel of | 60 | 3.729 |
| sample 6 | H.J. Unkel Co., Ltd. | | |

1. A one-package moisture curable composition comprising, by weight percentage based on the dry weight of the composition, from 10 to 99% at least one silane terminated polyurethane based polymer and from 1 to 90% at least one silane terminated polysiloxane based polymer; the composition, after being moisture cured, forms a surface whose water contact angle is larger than 101°.

2. The one-package moisture curable composition according to claim 1 wherein the silane terminated polyurethane based polymer comprising at least one end group of the general formula
-A-(CH₂)ₘ—SiR¹ₙ(OR²)₃₋ₙ
where A is a urethane or urea linkage group, R¹ is selected from C₁₋₁₂ alkyl, alkenyl, alkoxy, aminoalkyl, aryl and (meth)acryloxyalkyl groups, R² is each substituted or unsubstituted C₁₋₁₈ alkyl or C₆-C₂₀ aryl groups, m is an integer from 1 to 60, and n is an integer from 0 to 1.

3. The one-package moisture curable composition according to claim 1 wherein the silane terminated polyurethane is prepared by reacting at least one isocyanate functionalized silane with one or more polyol(s); or reacting at least one reactive group functionalized silane with isocyanate or hydroxyl terminated prepolymer which is selected from the group consisting of polyurethanes, polyureas, polyethers, polyesters, poly(meth)acrylates, polycarbonates, polystyrenes, polyamines or polyamides, polyvinyl esters, styrene/butadiene copolymers, polyolefins, polysiloxanes, and polysiloxane-urea/urethane copolymers.

4. The one-package moisture curable composition according to claim 3 wherein at least one of the polyol(s) is a natural oil derived polyol having at least one hydroxyl group per molecule, which is the reaction product of reactants (a) at least one polyester polyol or fatty acid derived polyol which is the reaction product of at least one initiator and a mixture of fatty acids or derivatives of fatty acids comprising at least about 45 weight percent monounsaturated fatty acids or derivatives thereof, (b) optionally, at least one polyol which is different from the polyol of (a).

5. The one-package moisture curable composition according to claim 3 wherein at least one of the polyol(s) is selected from the group consisting of polyester polyols, polyether polyols, polycarbonate polyols, acrylic polyols, polybutadiene polyols and polysiloxane polyols.

6. The one-package moisture curable composition according to claim 1 wherein the silane terminated polysiloxane has the formula 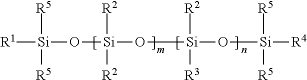
wherein at least one of R¹, R⁴ and R⁵ is a hydrolysable group having the formula —OR⁶, wherein R⁶ is a C₁-C₄ alkyl or C₆-C₂₀ aryl group, each of R² is independently a C₁-C₄ alkyl or a C₆-C₂₀ aryl, and R³ is a C₁-C₄ alkyl or a C₆-C₂₀ aryl or a substituted or unsubstituted C₁ to C₆₀ hydrocarbon radical, each of m and n is independently an integer from 0 to 1,500, and m+n≧2.

7. The one-package moisture curable composition according to claim 1 wherein the silane terminated polysiloxane is the reaction products of reactants
(a) at least one organofunctional polysiloxane the general formula 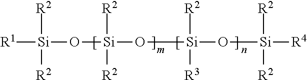
wherein at least one of R¹, R³ and R⁴ having at least one reactive functional X group selected from carbinol, amino, isocyanate, vinyl, epoxy, maleic anhydride, thiol and acrylic groups, R² is a C₁-C₄ alkyl or C₆-C₂₀ aryl, each of m and n is independently an integer from 0 to 1,500, and m+n≧2, and
(b) at least one organofunctional silane having at least one reactive functional Y group selected from hydroxyl, amino, isocyanate, epoxy, maleic anhydride, thiol, acrylic and vinyl groups whichever is capable of reacting with the X group.

8. A method for preparation of the composition of claim 1 comprising the following different ways, (i) mixing the silane terminated polyurethane based polymer and the silane terminated polysiloxane based polymer, or (ii) silylating a mixture of the polyurethane based polymer and the polysiloxane based polymer.

9. A method of coating a substrate comprising the steps of: providing the composition of claim 1, applying the composition to substrate and exposing to moisture to initiate the cure of the composition.

10. A coating composition comprising the one-package moisture curable composition according to claim 1.

11. The coating composition according to claim 10 wherein it comprises at least one biocide.

12. The coating composition according to claim 11 wherein the biocide is SEA-NINE™ 211, AMICAL™48, or the mixture thereof.

13. The coating composition according claim 10 wherein it is a marine antifouling coating, anti-icing coating, anti-stain coating, self-cleaning coating, or non-sticky coating.
